(19) United States
(12) Patent Application Publication
(10) Pub. No.: US 2016/0150486 A1
(43) Pub. Date: May 26, 2016

(54) METHOD FOR ADJUSTING A TRANSMISSION POWER

(71) Applicant: LG ELECTRONICS INC., Seoul (KR)

(72) Inventors: Sungjun PARK, Seoul (KR); Sunghoon JUNG, Seoul (KR); Seungjune YI, Seoul (KR); Youngdae LEE, Seoul (KR)

(73) Assignee: LG ELECTRONICS INC., Seoul (KR)

(21) Appl. No.: 14/904,370

(22) PCT Filed: Jul. 1, 2014
(86) PCT No.: PCT/KR2014/005837

§ 371 Date: Jan. 11, 2016

Related U.S. Application Data
(60) Provisional application No. 61/858,615, filed on Jul. 26, 2013.

(51) Int. Cl. H04W 52/34; H04W 16/32

(52) U.S. Cl. CPC H04W 52/34; H04W 16/32

(57) ABSTRACT

There is provided a method for adjusting a transmission power. The method may comprise: classifying, by a user equipment (UE), a plurality of cells into groups, each of which includes one or more cells belonging to the same base station; determining, by the UE, a transmission power for each group; and adjusting, by the UE, the determined transmission power for each group such that a summation of transmission powers for cells included in each group is less than or equal to a maximum transmission power configured for each group.

### FIELD OF THE INVENTION

The present invention relates to wireless communication, and more specifically, to a method for adjusting a transmission power.

### RELATED ART

3rd generation partnership project (3GPP) long term evolution (LTE) is an improved version of a universal mobile telecommunication system (UMTS) and is introduced as the 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas. In recent years, there is an ongoing discussion on 3GPP LTE-advanced (LTE-A) that is an evolution of the 3GPP LTE.

Examples of techniques employed in the 3GPP LTE-A include carrier aggregation.

The carrier aggregation uses a plurality of component carriers. The component carrier is defined with a center frequency and a bandwidth. One downlink component carrier or a pair of an uplink component carrier and a downlink component carrier is mapped to one cell. When a user equipment receives a service by using a plurality of downlink component carriers, it can be said that the user equipment receives the service from a plurality of serving cells. That is, the plurality of serving cells provides a user equipment with various services.

In recent, there is a discussion for adopting small cells.

### SUMMARY OF THE INVENTION

In the related art as above explained, due to adoption of the small cells, it will be possible for the UE to have dual connectivities to both a conventional cell and a small cell. However, there is yet no concept and technique to realize dual connectivities.

Therefore, an object of the present invention is to provide solutions to realize dual connectivities.

To achieve these and other advantages and in accordance with the purpose of the present invention, as embodied and broadly described herein, there is provided a method for adjusting a transmission power. The method may comprise: classifying, by a user equipment (UE), a plurality of cells into groups, each of which includes one or more cells belonging to the same base station; determining, by the UE, a transmission power for each group; and adjusting, by the UE, the determined transmission power for each group such that a summation of transmission powers for cells included in each group is less than or equal to a maximum transmission power configured for each group.

The method may further comprise: determining, by the UE, a transmission power for each cell; and adjusting, by the UE, the determined transmission power for each cell to be less than or equal to a maximum transmission power configured for each cell.

The method may further comprise: adjusting, by the UE, the determined transmission power for each cell such that a summation of transmission powers for the plurality of cells is less than or equal to a maximum transmission power configured for the UE.

The UE may have more than one connectivity to the plurality of cells

The group may be defined per a physical layer entity.

The maximum transmission power configured for each group may be expressed as PCMAX,e.

The maximum transmission power configured for each group may be calculated by amount of uplink (UL) grants.

The maximum transmission power configured for each group may be calculated by amount of UL transmission power.

The maximum transmission power configured for each group may be calculated by channel quality.

To achieve these and other advantages and in accordance with the purpose of the present invention, as embodied and broadly described herein, there is provided a user equipment (UE) for controlling a transmission power. The UE may comprise: a transceiver;

a processor connected with the transceiver and configured to classify a plurality of cells into groups, each of which includes one or more cells belonging to the same base station, determine a transmission power for each group, and adjust the determined transmission power for each group such that a summation of transmission powers for cells included in each group is less than or equal to a maximum transmission power configured for each group.

According to the present specification, the above-explained problem may be solved. In more detail, the UE can adjust the transmission power per each connectivity. Also, when the UE scales the transmission power in a power-limited state, the UE can put priority on a connectivity with MeNodeB which carries important information such as SRB.

### BRIEF DESCRIPTION OF THE DRAWINGS

FIG. 1 shows a wireless communication system to which the present invention is applied.

FIG. 2 is a diagram showing a radio protocol architecture for a user plane.

FIG. 3 is a diagram showing a radio protocol architecture for a control plane.

FIG. 4 shows an example of a wideband system using carrier aggregation for 3GPP LTE-A.

FIG. 5 shows an example of a structure of DL layer 2 when carrier aggregation is used.

FIG. 6 shows an example of a structure of UL layer 2 when carrier aggregation is used.

FIG. 7 shows an exemplary procedure for transmitting PUSCH.

FIG. 8 shows one exemplary concept of coexistence of a macro cell and small cells.

FIG. 9 shows one example of a first scenario of small cell deployment.

FIG. 10a shows one example of a second scenario of small cell deployment.

FIG. 10b shows another example of the second scenario of small cell deployment.

FIG. 11 shows one example of a third scenario of small cell deployment.

FIG. 12 shows a concept of dual connectivities

FIG. 13 shows radio protocols of eNodeBs for supporting dual connectivities.

FIG. 14 shows radio protocols of UE for supporting dual connectivities.

FIG. 15 shows one exemplary method according to the present disclosure.

FIG. 16 shows one example according to the method shown in FIG. 15.

FIG. 17 shows one exemplary summary of the present disclosure.

FIG. 18 is a block diagram showing a wireless communication system to implement an embodiment of the present invention.

### DESCRIPTION OF EXEMPLARY EMBODIMENTS

Reference will now be made in detail to the preferred embodiments of the present invention, examples of which are illustrated in the accompanying drawings. It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

Description will now be given in detail of a drain device and a refrigerator having the same according to an embodiment, with reference to the accompanying drawings.

The present invention will be described on the basis of a universal mobile telecommunication system (UMTS) and an evolved packet core (EPC). However, the present invention is not limited to such communication systems, and it may be also applicable to all kinds of communication systems and methods to which the technical spirit of the present invention is applied.

It should be noted that technological terms used herein are merely used to describe a specific embodiment, but not to limit the present invention. Also, unless particularly defined otherwise, technological terms used herein should be construed as a meaning that is generally understood by those having ordinary skill in the art to which the invention pertains, and should not be construed too broadly or too narrowly. Furthermore, if technological terms used herein are wrong terms unable to correctly express the spirit of the invention, then they should be replaced by technological terms that are properly understood by those skilled in the art. In addition, general terms used in this invention should be construed based on the definition of dictionary, or the context, and should not be construed too broadly or too narrowly.

Incidentally, unless clearly used otherwise, expressions in the singular number include a plural meaning. In this application, the terms “comprising” and “including” should not be construed to necessarily include all of the elements or steps disclosed herein, and should be construed not to include some of the elements or steps thereof, or should be construed to further include additional elements or steps.

The terms used herein including an ordinal number such as first, second, etc. can be used to describe various elements, but the elements should not be limited by those terms. The terms are used merely to distinguish an element from the other element. For example, a first element may be named to a second element, and similarly, a second element may be named to a first element.

In case where an element is “connected” or “linked” to the other element, it may be directly connected or linked to the other element, but another element may be existed therebetween. On the contrary, in case where an element is “directly connected” or “directly linked” to another element, it should be understood that any other element is not existed therebetween.

Hereinafter, preferred embodiments of the present invention will be described in detail with reference to the accompanying drawings, and the same or similar elements are designated with the same numeral references regardless of the numerals in the drawings and their redundant description will be omitted. In describing the present invention, moreover, the detailed description will be omitted when a specific description for publicly known technologies to which the invention pertains is judged to obscure the gist of the present invention. Also, it should be noted that the accompanying drawings are merely illustrated to easily explain the spirit of the invention, and therefore, they should not be construed to limit the spirit of the invention by the accompanying drawings. The spirit of the invention should be construed as being extended even to all changes, equivalents, and substitutes other than the accompanying drawings.

There is an exemplary UE (User Equipment) in accompanying drawings, however the UE may be referred to as terms such as a terminal, a mobile equipment (ME), a mobile station (MS), a user terminal (UT), a subscriber station (SS), a wireless device (WD), a handheld device (HD), an access terminal (AT), and etc. And, the UE may be implemented as a portable device such as a notebook, a mobile phone, a PDA, a smart phone, a multimedia device, etc, or as an unportable device such as a PC or a vehicle-mounted device.

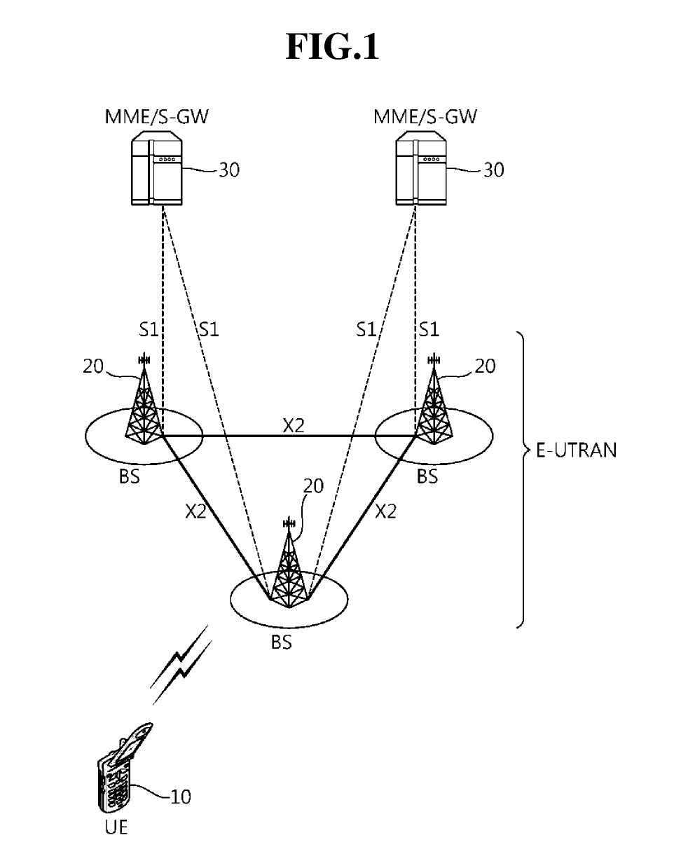

FIG. 1 shows a wireless communication system to which the present invention is applied.

The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNodeB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

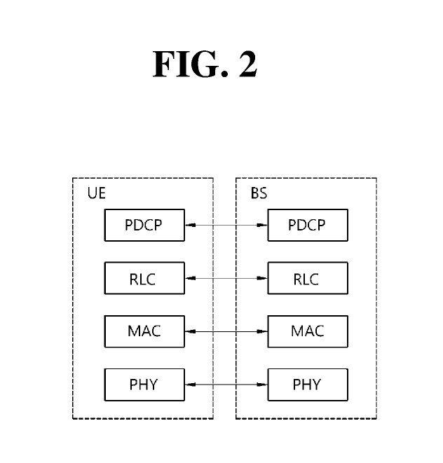

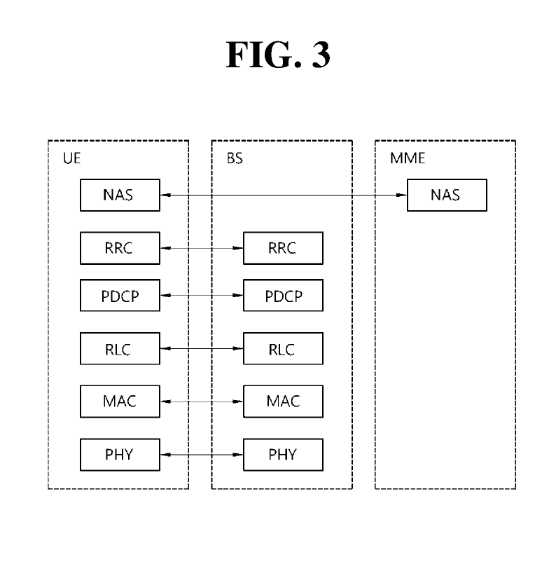

FIG. 2 is a diagram showing a radio protocol architecture for a user plane. FIG. 3 is a diagram showing a radio protocol architecture for a control plane.

The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Between different PHY layers, i.e., a PHY layer of a transmitter and a PHY layer of a receiver, data is transferred through the physical channel. The physical channel may be modulated using an orthogonal frequency division multiplexing (OFDM) scheme, and may utilize time and frequency as a radio resource.

Functions of the MAC layer include mapping between a logical channel and a transport channel and multiplexing/de-multiplexing on a transport block provided to a physical channel over a transport channel of a MAC service data unit (SDU) belonging to the logical channel. The MAC layer provides a service to a radio link control (RLC) layer through the logical channel.

Functions of the RLC layer include RLC SDU concatenation, segmentation, and reassembly. To ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides error correction by using an automatic repeat request (ARQ).

Functions of a packet data convergence protocol (PDCP) layer in the user plane include user data delivery, header compression, and ciphering. Functions of a PDCP layer in the control plane include control-plane data delivery and ciphering/integrity protection.

A radio resource control (RRC) layer is defined only in the control plane. The RRC layer serves to control the logical channel, the transport channel, and the physical channel in association with configuration, reconfiguration and release of radio bearers (RBs). An RB is a logical path provided by the first layer (i.e., the PHY layer) and the second layer (i.e., the MAC layer, the RLC layer, and the PDCP layer) for data delivery between the UE and the network.

The setup of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the network, the UE is in an RRC connected state (also may be referred as an RRC connected mode), and otherwise the UE is in an RRC idle state (also may be referred as an RRC idle mode).

Data is transmitted from the network to the UE through a downlink transport channel. Examples of the downlink transport channel include a broadcast channel (BCH) for transmitting system information and a downlink-shared channel (SCH) for transmitting user traffic or control messages. The user traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several subcarriers in a frequency domain. One subframe includes a plurality of OFDM symbols in the time domain. A resource block is a resource allocation unit, and includes a plurality of OFDM symbols and a plurality of subcarriers. Further, each subframe may use particular subcarriers of particular OFDM symbols (e.g., a first OFDM symbol) of a corresponding subframe for a physical downlink control channel (PDCCH), i.e., an L1/L2 control channel. A transmission time interval (TTI) is a unit time of subframe transmission.

Hereinafter, an RRC state of a UE and an RRC connection mechanism will be described.

The RRC state indicates whether an RRC layer of the UE is logically connected to an RRC layer of an E-UTRAN. If the two layers are connected to each other, it is called an RRC connected state, and if the two layers are not connected to each other, it is called an RRC idle state. When in the RRC connected state, the UE has an RRC connection and thus the E-UTRAN can recognize a presence of the UE in a cell unit. Accordingly, the UE can be effectively controlled. On the other hand, when in the RRC idle state, the UE cannot be recognized by the E-UTRAN, and is managed by a core network in a tracking area unit which is a unit of a wider area than a cell. That is, regarding the UE in the RRC idle state, only a presence or absence of the UE is recognized in a wide area unit. To get a typical mobile communication service such as voice or data, a transition to the RRC connected state is necessary.

When a user initially powers on the UE, the UE first searches for a proper cell and thereafter stays in the RRC idle state in the cell. Only when there is a need to establish an RRC connection, the UE staying in the RRC idle state establishes the RRC connection with the E-UTRAN through an RRC connection procedure and then transitions to the RRC connected state. Examples of a case where the UE in the RRC idle state needs to establish the RRC connection are various, such as a case where uplink data transmission is necessary due to telephony attempt of the user or the like or a case where a response message is transmitted in response to a paging message received from the E-UTRAN.

A non-access stratum (NAS) layer belongs to an upper layer of the RRC layer and serves to perform session management, mobility management, or the like.

Now, a radio link failure will be described.

A UE persistently performs measurement to maintain quality of a radio link with a serving cell from which the UE receives a service. The UE determines whether communication is impossible in a current situation due to deterioration of the quality of the radio link with the serving cell. If it is determined that the quality of the serving cell is so poor that communication is almost impossible, the UE determines the current situation as a radio link failure.

If the radio link failure is determined, the UE gives up maintaining communication with the current serving cell, selects a new cell through a cell selection (or cell reselection) procedure, and attempts RRC connection re-establishment to the new cell.

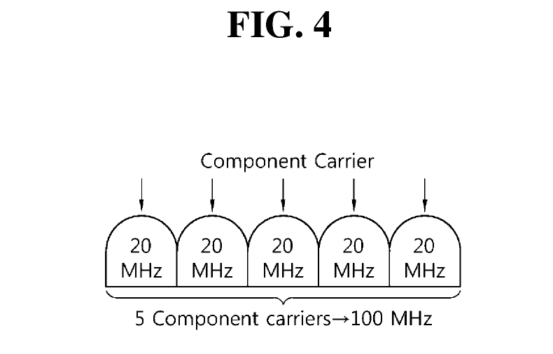

FIG. 4 shows an example of a wideband system using carrier aggregation for 3GPP LTE-A.

Referring to FIG. 4, each CC has a bandwidth of 20 MHz, which is a bandwidth of the 3GPP LTE. Up to 5 CCs may be aggregated, so maximum bandwidth of 100 MHz may be configured.

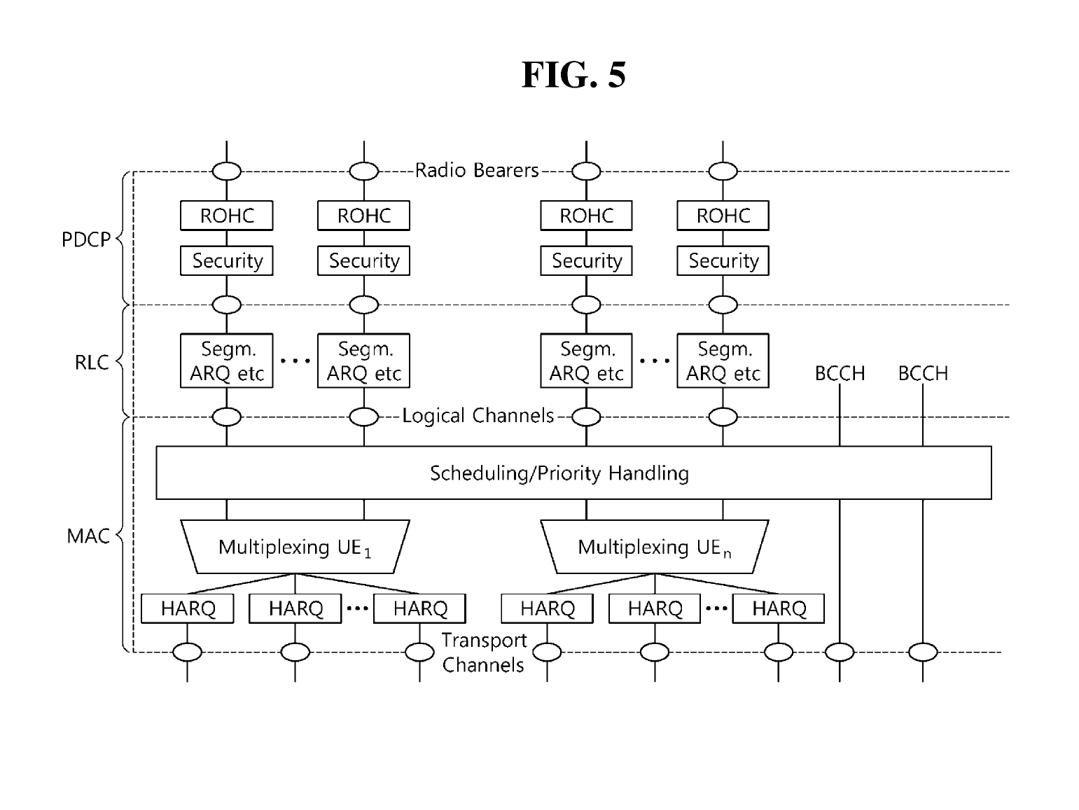

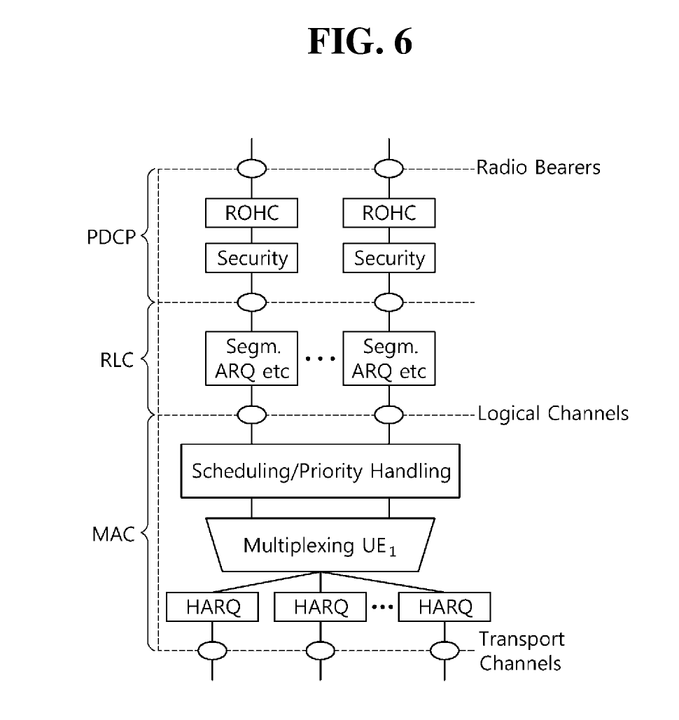

FIG. 5 shows an example of a structure of DL layer 2 when carrier aggregation is used. FIG. 6 shows an example of a structure of UL layer 2 when carrier aggregation is used.

The carrier aggregation may affect a MAC layer of the L2. For example, since the carrier aggregation uses a plurality of CCs, and each hybrid automatic repeat request (HARQ) entity manages each CC, the MAC layer of the 3GPP LTE-A using the carrier aggregation may perform operations related to a plurality of HARQ entities. In addition, each HARQ entity processes a transport block independently. Therefore, when the carrier aggregation is used, a plurality of transport blocks may be transmitted or received at the same time through a plurality of CCs.

<Transmission Power of PUSCH>

Now, a transmission power of PUSCH will be described below. It may be referred to Section 5.1.1 of 3GPP TS 36.213.

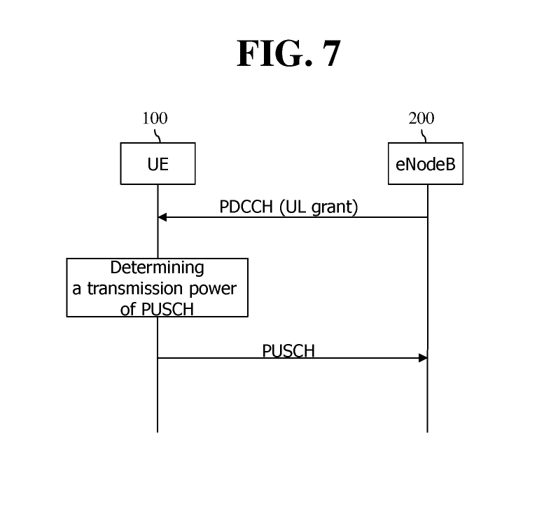

FIG. 7 shows an exemplary procedure for transmitting PUSCH.

Referring to FIG. 7, when a UE 100 receives a PDCCH including an uplink (UL) grant from eNodeB 200, the UE 100 determines a power for transmitting a PUSCH. Then, the UE 100 transmits the PUSCH according the determined power.

The power for transmitting PUSCH is defined as follows.

If the UE 100 transmits PUSCH without a simultaneous PUCCH for the serving cell c, then the transmission power of the UE P_{PUSCH,C(i)} for PUSCH transmission in subframe i for the serving cell c is calculated by

$${P}_{PUSCH , c} ( i ) = min \{ \begin{matrix}{P}_{CMAX , c} ( i ) , \\ \begin{matrix}10 {log}_{10} ( {M}_{PUSCH , c} ( i ) ) + {P}_{O\_PUSCH , c} ( j ) + \\ {α}_{c} ( j ) \cdot {PL}_{c} + {Δ}_{TF , c} ( i ) + {f}_{c} ( i )\end{matrix}\end{matrix} \} [ dBm ] \qquad [ Equation 1 ]$$

If the UE 100 transmits PUSCH simultaneous with PUCCH for the serving cell c, then the transmission power of the UE P_{PUSCH,C(i)} for the PUSCH transmission in subframe i for the serving cell c is calculated by

$${P}_{PUSCH , c} ( i ) = min \{ \begin{matrix}10 {log}_{10} ( {\hat{P}}_{CMAX , c} ( t ) - {\hat{P}}_{PUCCH} ( i ) ) , \\ \begin{matrix}10 {log}_{10} ( {M}_{PUSCH , c} ( i ) ) + {P}_{O\_PUSCH , c} ( j ) + \\ {α}_{c} ( j ) \cdot {PL}_{c} + {Δ}_{TF , c} ( i ) + {f}_{c} ( i )\end{matrix}\end{matrix} \} [ dBm ] \qquad [ Equation 2 ]$$

If the UE 100 is not transmitting PUSCH for the serving cell c, for the accumulation of TPC command received with DCI format 3/3A for PUSCH, the UE 100 assumes that the transmission power of the UE P_{PUSCH,C(i)} for the PUSCH transmission in subframe i for the serving cell c is calculated by

P_{PUSCH,c}(I)=min{P_{CMAX,c}(i),P_{O}_{_}_{PUSCH,c}(l)+α_{c}(l)·PL_{c}+f_{c}(i)} [Equation 3]

[dBm]

Where, P_{CMAX,c(i)} is the configured UE transmission power in subframe i for serving cell c and \hat{P}_{CMAX,c}(i) is the linear value of P_{CMAX,c(i)}. If the UE does not transmit PUCCH and PUSCH in subframe i for the serving cell c, for the accumulation of TPC command received with DCI format 3/3A for PUSCH, the UE may compute P_{CMAX,c(i)} assuming MPR=0 dB, A-MPR=0 dB, P-MPR=0 dB and T_{c}=0 dB

The \hat{P}_{PUCCH}(i) is the linear value of P_{PUCCH(i)}. M_{PUSCH,c(i)} is the bandwidth of the PUSCH resource assignment expressed in number of resource blocks valid for subframe i and serving cell c. P_{O}_{_}_{PUSCH,c(j)} is a parameter composed of the sum of a component P_{O}_{_}_{NOMINAL}_{_}_{PUSCH,c(j)} provided from higher layers for j=0 and 1 and a component P_{O}_{_}_{UE}_{_}_{PUSCH,c(j)} provided by higher layers for j=0 and 1 for serving cell c. For PUSCH (re)transmissions corresponding to a semi-persistent grant then j=0, for PUSCH (re)transmissions corresponding to a dynamic scheduled grant then j=1 and for PUSCH (re)transmissions corresponding to the random access response grant then j=2. P_{O}_{_}_{UE}_{_}_{PUSCH,c(2)}=0 and P_{O}_{_}_{NOMINAL}_{_}_{PUSCH,C(2)}=P_{O}_{_}_{PRE}+Δ_{PREAMBLE}_{_}_{Msg3}, where the parameter preambleInitialReceivedTargetPower (P_{O}_{_}_{PRE}) and Δ_{PREAMBLE}_{_}_{Msg3} are signalled from higher layers for serving cell c.

For j=0 or 1, α_{c}={0, 0.4, 0.5, 0.7, 0.8, 0.9, 1} is a 3-bit parameter provided by higher layers for serving cell c. For j=2, α_{c}(j)=1.

PL_{C} is the downlink pathloss estimate calculated in the UE for serving cell c in dB and PL_{C}=referenceSignalPower—higher layer filtered RSRP, where referenceSignalPower is provided by higher layers and RSRP is defined for the reference serving cell and the higher layer filter configuration is defined for the reference serving cell. If serving cell c belongs to a TAG containing the primary cell then, for the uplink of the primary cell, the primary cell is used as the reference serving cell for determining referenceSignalPower and higher layer filtered RSRP. For the uplink of the secondary cell, the serving cell configured by the higher layer parameter pathlossReferenceLinking is used as the reference serving cell for determining referenceSignalPower and higher layer filtered RSRP. If serving cell c belongs to a TAG not containing the primary cell then serving cell c is used as the reference serving cell for determining referenceSignalPower and higher layer filtered RSRP.

Δ_{TF,c}(i)=10 log₁₀((2^{BPRE-K}^{ₛ}−1)·β_{offset}^{PUSCH}) for K_{S}=1.25. Δ_{TF,c(i)}=0 for K_{S}=0. Where, K_{S} is given by the parameter deltaMCS-Enabled provided by higher layers for each serving cell c. BPRE and β_{offset}^{PUSCH}, for each serving cell c, are computed as below. K_{S}=0 for transmission mode 2.

BPRE=O_{CQI}/N_{RE} for control data sent via PUSCH without UL-SCH data and

$${\sum }_{r = 0}^{C - 1} {K}_{r} / {N}_{RE}$$

for other cases.

Where c is the number of code blocks, Kᵣ is the size for code block r, O_{CQI} is the number of CQI/PMI bits including CRC bits and N_{RE} is the number of resource elements determined as N_{RE}=M_{sc}^{PUSCH-initial}·N_{symb}^{PUSCH-initial}, where C, Kᵣ, M_{sc}^{PUSCH-initial} and N_{symb}^{PUSCH-initial} are defined in [4].

β_{offset}^{PUSCH}=β_{offset}^{CQI} for control data sent via PUSCH without UL-SCH data and β_{offset}^{PUSCH}=1 for other cases.

δ_{PUSCH,c} is a correction value, also referred to as a TPC command and is included in PDCCH/EPDCCH with DCI format 0/4 for serving cell c or jointly coded with other TPC commands in PDCCH with DCI format 3/3A whose CRC parity bits are scrambled with TPC-PUSCH-RNTI. The current PUSCH power control adjustment state for serving cell c is given by f_{c(i)} which is defined by:

f_{c}(i)=f_{c}(i−1)+δ_{PUSCH,c} (i−K_{PUSCH}) if accumulation is enabled based on the parameter Accumulation-enabled provided by higher layers or if the TPC command δ_{PUSCH,c} is included in a PDCCH/EPDCCH with DCI format 0 for serving cell c where the CRC is scrambled by the Temporary C-RNTI.

Where δ_{PUSCH,c} (i−K_{PUSCH}) was signalled on PDCCH/EPDCCH with DCI format 0/4 or PDCCH with DCI format 3/3A on subframe i−K_{PUSCH}, and where fc(0) is the first value after reset of accumulation.

For FDD, the value of K_{PUSCH} is 4. For TDD, if the UE is configured with more than one serving cell and the TDD UL/DL configuration of at least two configured serving cells is not the same, the “TDD UL/DL configuration” refers to the UL-reference UL/DL configuration for serving cell c

For TDD UL/DL configurations 1-6, K_{PUSCH} is given in below Table 1.

For TDD UL/DL configuration 0, if the PUSCH transmission in subframe 2 or 7 is scheduled with a PDCCH/EPDCCH of DCI format 0/4 in which the LSB of the UL index is set to 1, K_{PUSCH}=7 For all other PUSCH transmissions, K_{PUSCH} is given in below Table 1.

For serving cell c, the UE attempts to decode a PDCCH/EPDCCH of DCI format 0/4 with the UE's C-RNTI or DCI format 0 for SPS C-RNTI and a PDCCH of DCI format 3/3A with this UE's TPC-PUSCH-RNTI in every subframe except when in DRX or where serving cell c is deactivated.

If DCI format 0/4 for serving cell c and DCI format 3/3A are both detected in the same subframe, then the UE may use the δ_{PUSCH,c} provided in DCI format 0/4. δ_{PUSCH,c}=0 dB for a subframe where no TPC command is decoded for serving cell c or where DRX occurs or i is not an uplink subframe in TDD.

The δ_{PUSCH,c} dB accumulated values signalled on PDCCH/EPDCCH with DCI format 0/4 are given in below table. If the PDCCH/EPDCCH with DCI format 0 is validated as a SPS activation or release PDCCH/EPDCCH, then δ_{PUSCH,c} is 0 dB.

The δ_{PUSCH} dB accumulated values signaled on PDCCH with DCI format 3/3A are one of SET1 given in below Table 2 or SET2 given in Table 3 as determined by the parameter TPC-Index provided by higher layers.

If the UE has reached P_{CMAX,c(i)} for serving cell c, positive TPC commands for serving cell c may not be accumulated. If the UE has reached minimum power, negative TPC commands may not be accumulated. The UE reset accumulation.

For serving cell c, when P_{O}_{_}_{UE}_{_}_{PUSCH,c} value is changed by higher layers

For serving cell c, when the UE receives random access response message for serving cell c. f_{c}(i)=δ_{PUSCH,c}(i−K_{PUSCH}) if accumulation is not enabled for serving cell c based on the parameter Accumulation-enabled provided by higher layers.

Where δ_{PUSCH,c}(i−K_{PUSCH}) is signalled on PDCCH/EPDCCH with DCI format 0/4 for serving cell c on subframe i−K_{PUSCH}

For FDD, K_{PUSCH}=4. For TDD, if the UE is configured with more than one serving cell and the TDD UL/DL configuration of at least two configured serving cells is not the same, the “TDD UL/DL configuration” refers to the UL-reference UL/DL configuration for serving cell c. For TDD UL/DL configurations 1-6, K_{PUSCH} is given in Table 1.

For TDD UL/DL configuration 0. If the PUSCH transmission in subframe 2 or 7 is scheduled with a PDCCH/EPDCCH of DCI format 0/4 in which the LSB of the UL index is set to 1, K_{PUSCH}=7. For all other PUSCH transmissions, K_{PUSCH} is given in Table 1.

The δ_{PUSCH,c} dB absolute values signaled on PDCCH/EPDCCH with DCI format 0/4 are given in Table 2. If the PDCCH/EPDCCH with DCI format 0 is validated as a SPS activation or release PDCCH/EPDCCH, then δ_{PUSCH,c} is 0 dB.

f_{c}(i)=f_{c}(i−1) for a subframe where no PDCCH/EPDCCH with DCI format 0/4 is decoded for serving cell c or where DRX occurs or i is not an uplink subframe in TDD.

For both types of f_{c}(*) (accumulation or current absolute) the first value is set as follows: If P_{O}_{_}_{UE}_{_}_{PUSCH,c} value is changed by higher layers and serving cell c is the primary cell or, if P_{O}_{_}_{UE}_{_}_{PUSCH,c} value is received by higher layers and serving cell c is a Secondary cell, f_{c}(0)=0.

Else, If the UE receives the random access response message for a serving cell c, f_{c}(0)ΔP_{rampup,c}+δ_{msg2,c}, where δ_{msg2,c} is the TPC command indicated in the random access response corresponding to the random access preamble transmitted in the serving cell c

$$Δ {P}_{rampup , c} = min [ \{ max ( 0 , {P}_{CMAX , c} - ( \begin{matrix}10 {log}_{10} ( {M}_{PUSCH , c} ( 0 ) ) + \\ {P}_{O\_PUSCH , c} ( 2 ) + {δ}_{msg 2} + \\ {α}_{c} ( 2 ) \cdot PL + {Δ}_{TF , c} ( 0 )\end{matrix} ) ) \} , Δ {P}_{rampuprequested , c} ] \qquad [ Equation 4 ]$$

The Δp_{rampuprequested,c} is provided by higher layers and corresponds to the total power ramp-up requested by higher layers from the first to the last preamble in the serving cell c, M_{PUSCH,c(0)} is the bandwidth of the PUSCH resource assignment expressed in number of resource blocks valid for the subframe of first PUSCH transmission in the serving cell c, and Δ_{TF,c}(0) is the power adjustment of first PUSCH transmission in the serving cell c.

TABLE 1

| TDD UL/DL | subframe number i | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | 7 | 4 | — | — | 6 | 7 | 4 |
| 1 | — | — | 6 | 4 | — | — | — | 6 | 4 | — |
| 2 | — | — | 4 | — | — | — | — | 4 | — | — |
| 3 | — | — | 4 | 4 | 4 | — | — | — | — | — |
| 4 | — | — | 4 | 4 | — | — | — | — | — | — |
| 5 | — | — | 4 | — | — | — | — | — | — | — |
| 6 | — | — | 7 | 7 | 5 | — | — | 7 | 7 | — |

TABLE 2

| TPC Command | | |
|---|---|---|
| Field in | Accumulated | Absolute δ_{PUSCH,c} [dB] |
| DCI format 0/3/4 | δ_{PUSCH,c} [dB] | only DCI format 0/4 |
| 0 | −1 | −4 |
| 1 | 0 | −1 |
| 2 | 1 | 1 |
| 3 | 3 | 4 |

TABLE 3

| TPC Command Field in | |
|---|---|
| DCI format 3A | Accumulated δ_{PUSCH,c} [dB] |
| 0 | −1 |
| 1 | 1 |

If the total transmission power of the UE would exceed \hat{P}_{CMAX}(x), the UE scales \hat{P}_{PUSCH,c} (i) for the serving cell c in subframe i such that the condition

$${\sum }_{c} w ( i ) \cdot {\hat{P}}_{PUSCH , c} ( i ) \leq ( {\hat{P}}_{CMAX} ( i ) - {\hat{P}}_{PUCCH} ( i ) ) \qquad [ Equation 5 ]$$

is satisfied where \hat{P}_{PUCCH}(i) is the linear value of P_{PUCCH(i)}, \hat{P}_{PUSCH,c}(i) is the linear value of P_{PUCCH,c}(i), \hat{P}_{CMAX}(i) is the linear value of the UE total configured maximum output power P_{CMAX} in subframe i and w(i) is a scaling factor of \hat{P}_{PUSCH,c}(i) for serving cell c where 0≦w(i)≦1. In case there is no PUCCH transmission in subframe i \hat{P}_{PUCCH}(i)=0.

If the UE has PUSCH transmission with UCI on serving cell j and PUSCH without UCI in any of the remaining serving cells, and the total transmission power of the UE would exceed \hat{P}_{CMAX}(i), the UE scales \hat{P}_{PUSCH,c}(i) for the serving cells without UCI in subframe i such that the following condition

$${\sum }_{c \neq j} w ( i ) \cdot {\hat{P}}_{PUSCH , c} ( i ) \leq ( {\hat{P}}_{CMAX} ( i ) - {\hat{P}}_{PUCCH} ( i ) ) \qquad [ Equation 6 ]$$

is satisfied where \hat{P}_{PUSCH,j}(i) is the PUSCH transmission power for the cell with UCI and w(i) is a scaling factor of \hat{P}_{PUSCH,c}(i) for serving cellc without UCI. In this case, no power scaling is applied to \hat{P}_{PUSCH,j}(i) unless

$${\sum }_{c \neq j} w ( i ) \cdot {\hat{P}}_{PUSCH , c} ( i ) = 0$$

and the total transmission power of the UE still would exceed \hat{P}_{CMAX}(i). Note that w(i) values are the same across serving cells when w(i)>0 but for certain serving cells w(i) may be zero.

If the UE has simultaneous PUCCH and PUSCH transmission with UCI on serving cell j and PUSCH transmission without UCI in any of the remaining serving cells, and the total transmission power of the UE would exceed \hat{P}_{CMAX}(i), the UE obtains \hat{P}_{PUSCH,c}(i) according to

$$\begin{matrix}{\hat{P}}_{PUSCH , j} ( i ) = min ( {\hat{P}}_{PUSCH , j} ( i ) , ( {\hat{P}}_{CMAX} ( i ) - {\hat{P}}_{PUCCH} ( i ) ) ) & [ Equation 7 ] \\ {\sum }_{c \neq j} w ( i ) \cdot {\hat{P}}_{PUSCH , c} ( i ) \leq ( {\hat{P}}_{CMAX} ( i ) - {\hat{P}}_{PUCCH} ( i ) - {\hat{P}}_{PUSCH , j} ( i ) ) & [ Equation 8 ]\end{matrix}$$

If the UE is configured with multiple TAGs, and if the PUCCH/PUSCH transmission of the UE on subframe i for a given serving cell in a TAG overlaps some portion of the first symbol of the PUSCH transmission on subframe i+1 for a different serving cell in another TAG the UE may adjust its total transmission power to not exceed 1+P_{CMAX} on any overlapped portion.

If the UE is configured with multiple TAGs, and if the PUSCH transmission of the UE on subframe i for a given serving cell in a TAG overlaps some portion of the first symbol of the PUCCH transmission on subframe i+1 for a different serving cell in another TAG the UE may adjust its total transmission power to not exceed P_{CMAX} on any overlapped portion.

If the UE is configured with multiple TAGs, and if the SRS transmission of the UE in a symbol on subframe i for a given serving cell in a TAG overlaps with the PUCCH/PUSCH transmission on subframe i or subframe i+1 for a different serving cell in the same or another TAG the UE may drop SRS if its total transmission power exceeds 1+P_{CMAX} on any overlapped portion of the symbol.

If the UE is configured with multiple TAGS and more than 2 serving cells, and if the SRS transmission of the UE in a symbol on subframe i for a given serving cell overlaps with the SRS transmission on subframe i for a different serving cell(s) and with PUSCH/PUCCH transmission on subframe i or subframe i+1 for another serving cell(s) the UE may drop the SRS transmissions if the total transmission power exceeds P_{CMAX} on any overlapped portion of the symbol.

If the UE is configured with multiple TAGs, the UE may, when requested by higher layers, to transmit PRACH in a secondary serving cell in parallel with SRS transmission in a symbol on a subframe of a different serving cell belonging to a different TAG, drop SRS if the total transmission power exceeds P_{CMAX} on any overlapped portion in the symbol.

If the UE is configured with multiple TAGs, the UE may, when requested by higher layers, to transmit PRACH in a secondary serving cell in parallel with PUSCH/PUCCH in a different serving cell belonging to a different TAG, adjust the transmission power of PUSCH/PUCCH so that its total transmission power does not exceed P_{CMAX} on the overlapped portion.

<Small Cell>

Now, a concept of small cell will be described.

In the 3rd or 4th mobile communication system, an attempt to increase a cell capacity is continuously made in order to support a high-capacity service and a bidirectional service such as multimedia contents, streaming, and the like.

That is, as various large-capacity transmission technologies are required with development of communication and spread of multimedia technology, a method for increase a radio capacity includes a method of allocating more frequency resources, but there is a limit in allocating more frequency resources to a plurality of users with limited frequency resources.

An approach to use a high-frequency band and decrease a cell radius has been made in order to increase the cell capacity. When a small cell such as a pico cell or femto cell is adopted, a band higher than a frequency used in the existing cellular system may be used, and as a result, it is possible to transfer more information.

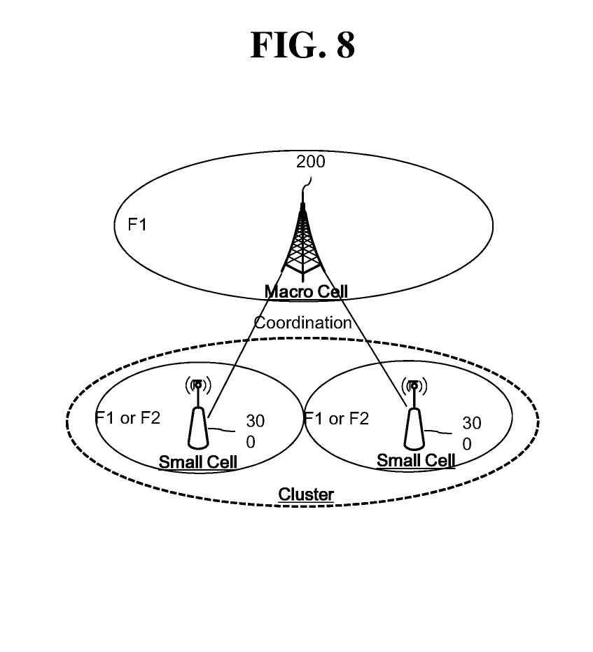

FIG. 8 shows one exemplary concept of coexistence of a macro cell and small cells.

As shown in FIG. 8, a cell of a conventional BS or eNodeB 200 may be called as a macro cell over small cells. Each small cell is operated by each small BS or eNodeB (300). When the conventional BS or eNodeB 200 may operate in use of a frequency F1, each small cell operates in use of a frequency F1 or F2. Small cells may be grouped in a cluster. It is noted that actual deployment of small cells are varied depending on operator's policy.

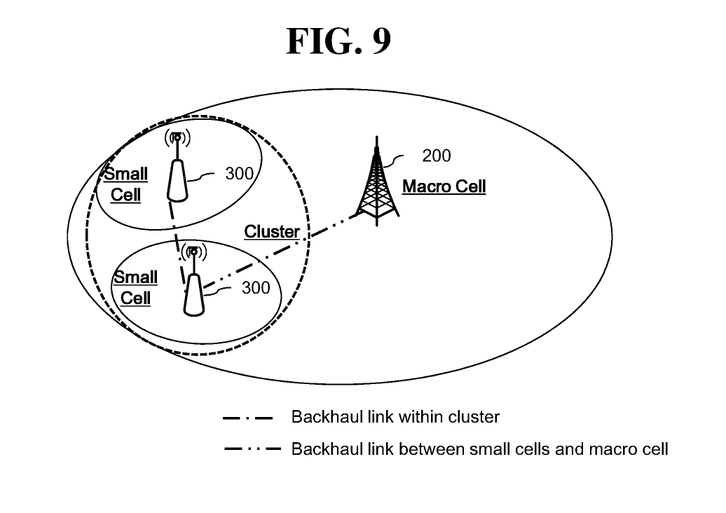

FIG. 9 shows one example of a first scenario of small cell deployment.

As shown in FIG. 9, the small cells may be deployed in the presence of an overlaid macro cell. That is, the small cells may be deployed in a coverage of the macro cell. In such deployment, the following may be considered.
Co-channel deployment of the macro cell and small cells
Outdoor small cell deployment
Small cell cluster is considered
The small cells are dense in cluster
Details regarding the number/density of small cells per cluster, backhaul link for coordination among small cells and time synchronization among small cells may also be considered
Both ideal backhaul and non-ideal backhaul may be also considered for the following interfaces: an interface between the small cells within the same cluster and an interface between a cluster of small cells and at least one macro eNodeB.
Non-ideal backhaul is assumed for all other interfaces.

Here, the non-ideal backhaul means that there may be a delay up to 60 ms.

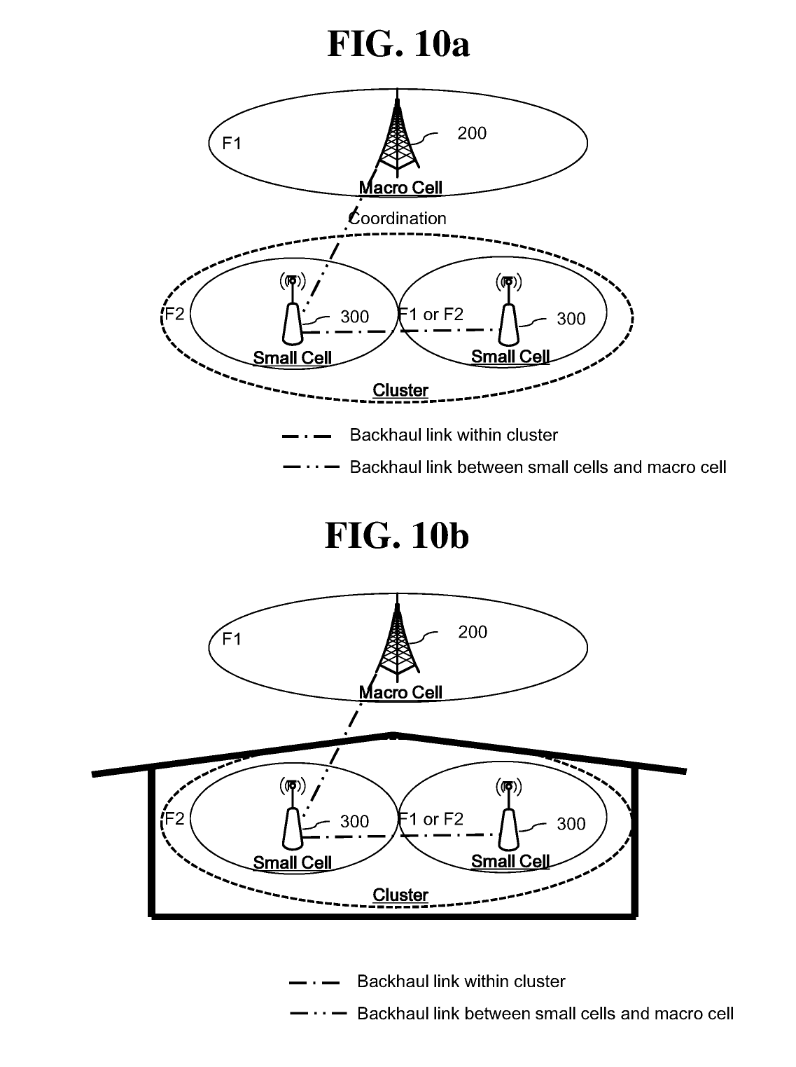

FIG. 10a shows one example of a second scenario of small cell deployment.

As shown in FIG. 10a, the small cells may be deployed outdoor. In such deployment, the following may be considered.
The small cells are deployed in the presence of an overlaid macro network
Separate frequency deployment of the macro cell and small cells
Outdoor small cell deployment
Small cell cluster is considered
The small cells are dense in cluster
Details regarding the number/density of small cells per cluster, backhaul link for coordination among small cells and time synchronization among small cells may also be considered.
Both ideal backhaul and non-ideal backhaul may be also considered for the following interfaces: an interface between the small cells within the same cluster and an interface between a cluster of small cells and at least one macro eNB
Non-ideal backhaul is assumed for all other interfaces

FIG. 10b shows another example of the second scenario of small cell deployment.

As shown in FIG. 10b, the small cells may be deployed indoor. In such deployment, the following may be considered.
The small cells are deployed in the presence of an overlaid macro network
Separate frequency deployment of the macro cell and small cells
Indoor small cell deployment is considered
Small cell cluster is considered
The small cells are dense in cluster
Details regarding the number/density of small cells per cluster, backhaul link for coordination among small cells and time synchronization among small cells may also be considered.
A sparse scenario can be also considered such as the indoor hotspot scenario.
Both ideal backhaul and non-ideal backhaul may be also considered for the following interfaces: an interface between the small cells within the same cluster and an interface between a cluster of small cells and at least one macro eNB
Non-ideal backhaul is assumed for all other interfaces.

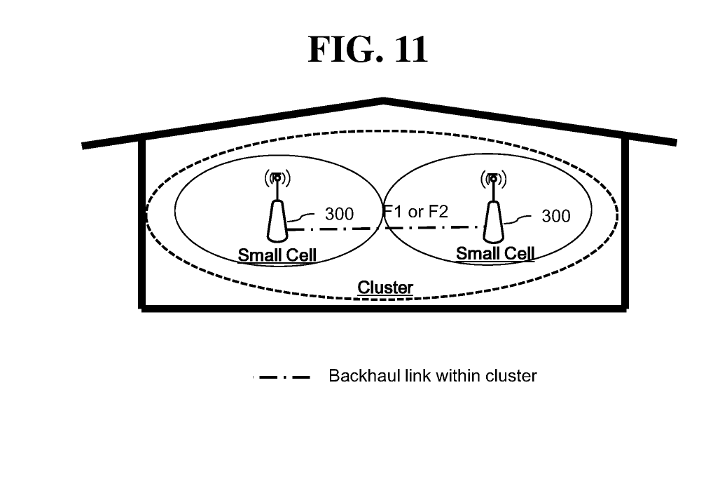

FIG. 11 shows one example of a third scenario of small cell deployment.

As shown in FIG. 11, the small cells may be deployed indoor. In such deployment, the following may be considered.
Macro cell coverage is not present
Indoor deployment scenario is considered
Small cell cluster is considered
The small cells are dense in cluster
Details regarding the number/density of small cells per cluster, backhaul link for coordination among small cells and time synchronization among small cells may also be considered.
A sparse scenario can be considered such as the indoor hotspot scenario.
Both ideal backhaul and non-ideal backhaul may be also considered for the following interfaces: an interface between the small cells within the same cluster.
Non-ideal backhaul is assumed for all other interfaces.

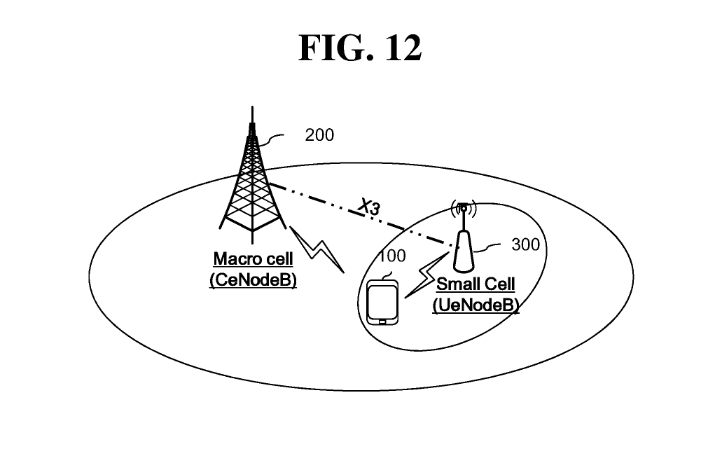

FIG. 12 shows a concept of dual connectivities

As illustrated in FIG. 12, the UE 100 has dual connectivities to both Macro cell and small cell. Here, the connectivity means the connection to eNodeB for data transfer. If the UE is served by both one macro cell and one small cell, it can be said that the UE has dual connectivities, i.e., one connectivity for the macro cell and another connectivity for the small cell. If the UE is served by small cells, it can be said that the UE has multiple connectivity.

The macro cell is served by a Macro eNodeB (hereinafter, “MeNodeB”) and the small cell or group of small cells is served by a Small eNodeB (hereinafter, “SeNodeB”). Meanwhile, if a cell is responsible for managing control plane specific operations, e.g., RRC connection control and mobility, e.g., transfer of control data on signaling radio bearers (SRBs), an eNodeB of the cell may be called as User-plane eNodeB (hereinafter, “UeNodeB” or “UeNB”). On the other hand, if a cell is responsible for managing user plane specific operations, e.g., transfer of data on data radio bearers (DRBs), an eNodeB of the cell may be called as Control-plane eNodeB (hereinafter, “CeNodeB” or “CeNB”).

In this FIG. 12, the MeNodeB corresponds to a CeNodeB and the SeNodeB corresponds to UeNodeB.

The small cell of UeNodeB is responsible for transmitting best effort (BE) type traffic, while the macro cell of the CeNodeB is responsible for transmitting other types of traffic such as VoIP, streaming data, or signaling data.

It is noted that there is X3 interface between CeNodeB and UeNodeB that is similar to conventional X2 interface between eNodeBs.

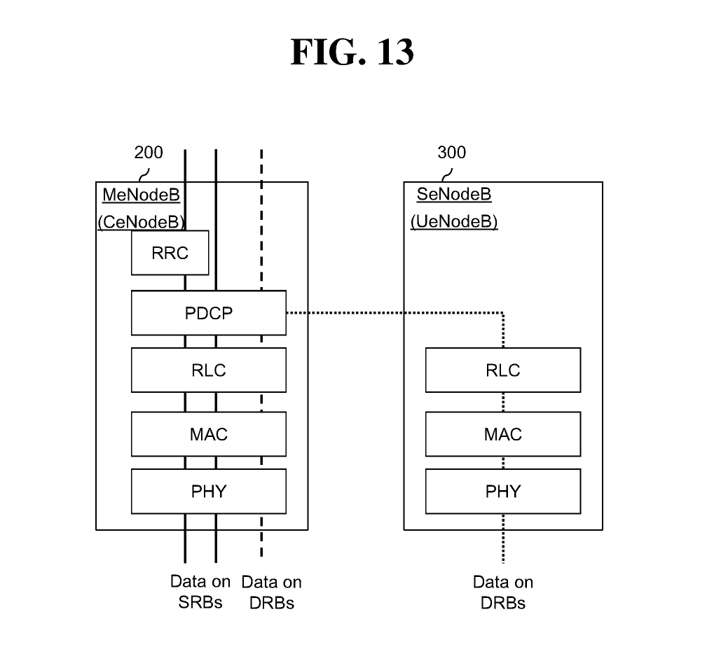

FIG. 13 shows radio protocols of eNodeBs for supporting dual connectivities.

For dual or multiple connectivities, MAC functions of the UE 100 needs to be newly defined because from Layer 2 protocol point of view, RLC functions and configurations are bearer-specific while MAC functions and configurations are not.

To support dual or multiple connectivities, various protocol architectures are studied, and one of potential architectures is shown in FIG. 13. In this architecture, PDCP entity for UeNodeB is located in different network nodes, i.e. PDCP in CeNodeB.

As shown in FIG. 13, CeNodeB includes a PHY layer, a MAC layer, an RLC layer, a PDCH layer and an RRC layer while the UeNodeB includes a PHY layer, a MAC layer and an RLC layer. It is noted that the RRC layer and the PDCP layer exist only in the CeNodeB. In other words, there is the common RRC and PDCP layer and there is a set of RLC, MAC and PHY layers per connectivity. Accordingly, data on SRBs is signaled on CeNodeB and data on DRBs is signaled on either CeNodeB or UeNodeB according to the DRB configurations. That is, the CeNodeB can deliver data on DRBs in addition to control data on SRBs, while the UeNodeB can deliver data on only DRBs.

Here, the followings are considered:
CeNodeB and UeNodeB can be different nodes.
Transfer of data on SRBs is performed on CeNodeB.
Transfer of data on DRBs is performed on either CeNodeB or UeNodeB.

Whether path of data on DRBs is on CeNodeB or UeNodeB can be configured by the eNodeB, MME, or S-GW.
There is X3 interface between CeNodeB and UeNodeB that is similar to conventional X2 interface between eNodeBs.
Because RRC connection reconfiguration is managed in the CeNodeB, the CeNodeB sends information about DRB configurations to UeNodeB via X3 interface.

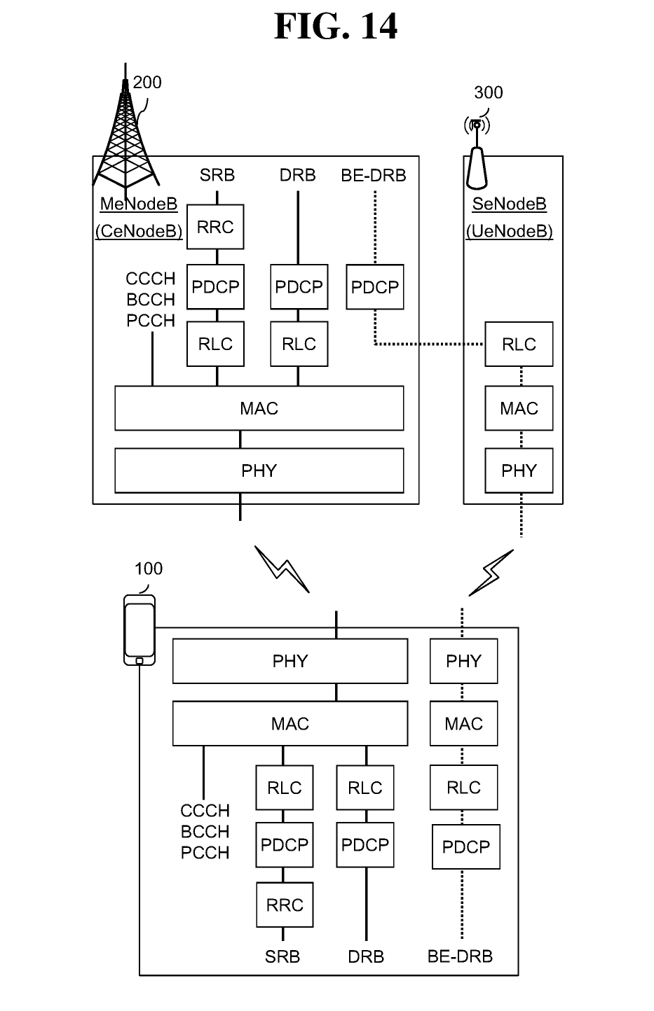

FIG. 14 shows radio protocols of UE for supporting dual connectivities.

As shown in FIG. 14, the UeNodeB is responsible for transmitting best effort (BE) DRB. The CeNodeB is responsible for transmitting SRB and DRB. As above explained, PDCP entity for UeNodeB is located in CeNodeB.

As shown in FIG. 14, on the UE 100 side, there are more than one MAC entities for macro cell of CeNodeB and small cells of UeNodeB. In other word, the UE 100 setups each MAC entity for each connectivity. Accordingly, the UE 100 includes at least two MAC entities for dual or multiple connectivities. Also, the UE 100 includes at least two PHY entities for dual connectivities. Here, a first PHY entity handles a first connectivity to the macro cell of CeNodeB and a second PHY entity handles a second connectivity to the small cell of the UeNodeB. The first PHY entity may be called as a M-PHY entity or a C-PHY entity. The second PHY entity may be called as a S-PHY entity or a U-PHY entity. Meanwhile, for the connectivity to UeNodeB, the UE 100 may include the PDCP entity, the RLC entity and the MAC entity which handle BE-DRB. For connectivity to CeNodeB, the UE 100 may include plural RLC entities, plural PDCP entities which handle SRB and DRB.

Meanwhile, each of the CeNodeB and the UeNodeB owns a radio resource for itself and include a scheduler for scheduling the radio resource for itself. Here, each scheduler and each connectivity are 1-to-1 mapping.

As such, the UE 100 includes the two PHY entities which are operated independently each other because scheduling nodes of each PHY are located in different network nodes.

But, a conventional technique for scaling the transmission power of the UE was provided in consideration of one PHY entity. In more detail, when the UE has only one PHY entity, and is configured with more than one cell, the UE performs the following two steps for power scaling: a) scaling a transmission power of the UE for each serving cell such that the transmission power of the UE is less than or less than a first configured transmission power on the serving cell (called PCMAX,c); and b) further scaling the transmission power of the UE for each serving cell such that the sum of the transmission power for each serving cell is less than or equal to than a second configured transmission power (called PCMAX)

However, if two PHY entities in the UE are operating, the eNodeB may want to control the transmission power of the UE per PHY entity. However, there was a problem that there is no means for it.

### One Exemplary Solution According to the Present Disclosure

Therefore, the present disclosure provides a solution to the power scaling for the UE including two PHY entities.

For the solution, the present disclosure provides one example technique. According to the technique, when the UE has a dual connectivity using more than one PHY entity (e.g., M-PHY and S-PHY), the transmission power of the UE for a serving cell is scaled to satisfy a condition that the sum of the transmission power of the UE for serving cells of a PHY entity is less than or equal to the configured transmission power on the PHY entity (called P_{CMAX,e}).

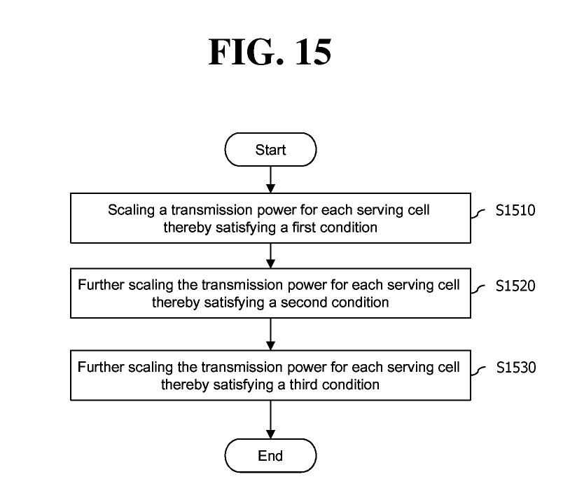

FIG. 15 Shows One Exemplary Method According to the Present Disclosure.

Referring to FIG. 15, the transmission power of the UE for serving cells is scaled with the following steps.

At step S1510, the UE 100 scales the transmission power for each serving cell thereby satisfying a first condition that the transmission power is less than or equal to a first configured transmission power on the serving cell (P_{CMAX,c}).

At step S1520, the UE 100 further scales the transmission power for each serving cell thereby satisfying a second condition that the sum of the transmission power for each serving cell is less than or equal to a second configured transmission power on the corresponding PHY entity (P_{CMAX,e})

At step S1530, the UE 100 further scales the transmission power for each serving cell thereby satisfying a third condition such that the sum of the transmission power for each serving cell is less than or equal to a third configured transmission power (P_{CMAX}).

Here, the P_{CMAX,e} which is defined per PHY entity is an example, can be defined as one of the following:
P_{CMAX,e} per cell or group of cells
P_{CMAX,e} per scheduler
P_{CMAX,e} per eNodeB
P_{CMAX,e} per RF unit (chain)
P_{CMAX,e} per physical (logical) connectivity
P_{CMAX,e} per MAC, RLC, PDCP, RRC entity

The transmission power include power for one or some of the following: PUSCH with UCI, PUSCH without UCI, PUCCH, SRS and PRACH

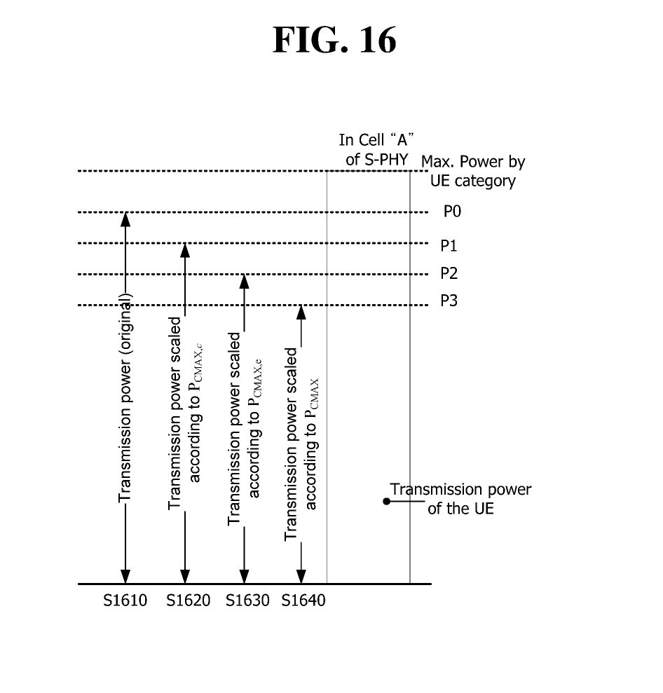

FIG. 16 shows one example according to the method shown in FIG. 15.

Referring to FIG. 16, in step S1610, the transmission power on Cell “A” is estimated to P0 based on e.g., UL grant or etc.

In step S1620, the transmission power P0 is scaled down to P1 to satisfy a first condition that P0 is less than or equal to P_{CMAX,c}. Here, if P0 is already satisfied with the first condition, the power scaling of P0 may not be performed.

In step S1630, the transmission power P1 is further scaled down to P2 to satisfy a second condition that the sum of the transmission power of cells including cell “A” in S-PHY is equal to or less than P_{CMAX,e}. Here, if P1 is already satisfied with the second condition, the power scaling of P1 may not be performed.

In step S1640, the transmission power P2 is further scaled down to P3 to satisfy a third condition that the sum of the transmission power for each serving cell is less than or equal to P_{CMAX}. Here, if P2 is already satisfied with the third condition, the power scaling of P2 is not needed.

As results of these steps S1610˜S1640, the UE may transmit the UL by using P3.

On the other hand, exemplary ways for calculating P_{CMAX,e} will be explained.

For explanation of the ways, it is assumed that the UE has M-PHY and S-PHY and needs to transmit uplink signals via both M-PHY and S-PHY at the same or similar time. Also, it is further assumed that the reference value for calculating P_{CMAX,e} can be signaled to the UE or calculated by the UE.

A first way: P_{CMAX,e} may be calculated according to amount of UL grant

In the first way, a weight factor (called WF) is defined, 0<WF<=1. WF can be signaled to the UE from the eNodeB. Then, the UE compares amount of the UL grant for M-PHY and the UL grant for S-PHY (hereinafter UL grant for M-PHY is called M-UL grant and UL grant for S-PHY is called S-UL grant). Then, WF is applied to P_{CMAX,e} for PHY entity having lower amount of UL grant. For example, if M-UL grant>S-UL grant, WF is applied to P_{CMAX,e} for S-PHY. That is, P_{CMAX,e} for M-PHY=the reference value and P_{CMAX,e} for S-PHY=WF*reference value. Alternatively, WF can be applied to P_{CMAX,e} for PHY entity having higher amount of UL grant.

A second way: P_{CMAX,e} may be calculated according to amount of UL transmission power

In the second way, a weight fact (called WF) is defined, 0<WF<=1. WF can be signaled to the UE from the eNodeB. Then, the UE compares amount of UE transmission power required for M-PHY and for S-PHY. In FIG. 13, the UE compares amount of P1 for M-PHY and S-PHY. Then, WF is applied to P_{CMAX,e} for PHY entity having lower amount of UL transmission power. For example, as shown in FIG. 13, if P1 for M-PHY>P1 for S-PHY, WF is applied to for S-PHY. That is, P_{CMAX,e} for M-PHY=the reference value and P_{CMAX,e} for S-PHY=WF*reference value. Alternatively, WF can be applied to P_{CMAX,e} for PHY entity having higher amount of UE transmission power.

A third way: P_{CMAX,e} may be calculated according to channel quality

In the third way, a weight fact (called WF) is defined, 0<WF<=1. WF can be signaled to the UE from the eNodeB. Then, the UE compares the measured channel quality associated with M-PHY and S-PHY. Then, WF is applied to P_{CMAX,e} for PHY entity having a worse channel quality. For example, if channel quality associated with M-PHY is better than that channel quality associated with S-PHY, WF is applied to S-PHY. That is, P_{CMAX,e} for M-PHY=the reference value and P_{CMAX,e} for S-PHY=WF*reference value. Alternatively, WF can be applied to P_{CMAX,e} for PHY entity having better channel quality.

A fourth way: P_{CMAX,e} may be calculated according to radio

In the fourth way, a weight fact (called WF) is defined, 0<WF<=1. WF for each PHY entity is signaled to the UE from the eNodeB. Then, each WF is applied to P_{CMAX,e} for corresponding PHY entity. Therefore, P_{CMAX,e} for M-PHY=WF for M-PHY*the reference value and P_{CMAX,e} for S-PHY=WF for S-PHY*reference value

In such a manner, the UE can adjust the transmission power per each connectivity. Also, when the UE scales the transmission power in a power-limited state, the UE can put priority on a connectivity with MeNodeB which carries important information such as SRB.

Hereinafter, a summary of the present disclosure will be described.

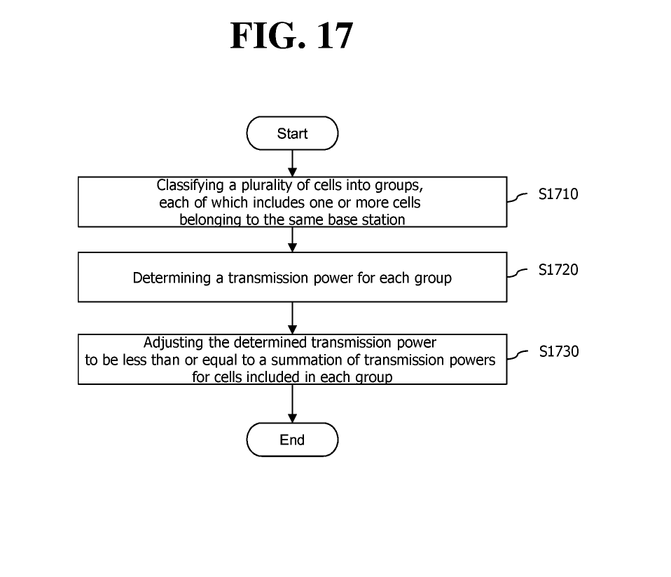

FIG. 17 Shows One Exemplary Summary of the Present Disclosure.

Referring to FIG. 17, the UE classifies a plurality of cells into groups, each of which includes one or more cells belonging to the same base station (S1710). And, the UE determines a transmission power for each group (S1720). Then, the UE adjusts the determined transmission power to be less than or equal to a summation of transmission powers for cells included in each group (S1730).

The ways or methods to solve the problem of the related art according to the present disclosure, as described so far, can be implemented by hardware or software, or any combination thereof

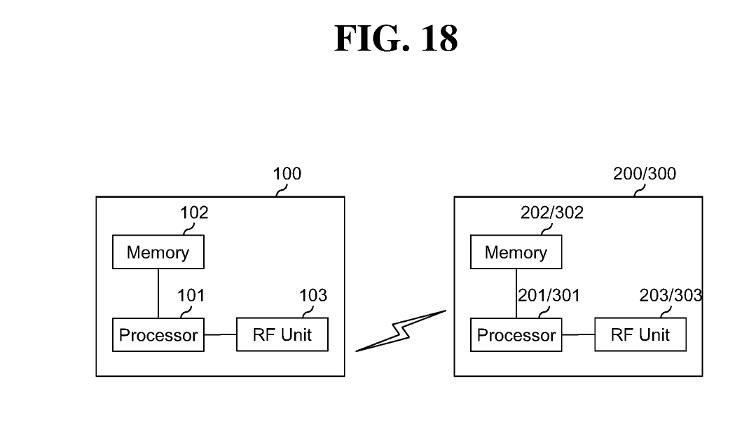

FIG. 18 is a Block Diagram Showing a Wireless Communication System to Implement an Embodiment of the Present Invention.

An UE 100 includes a processor 101, memory 102, and a radio frequency (RF) unit 103. The memory 102 is connected to the processor 101 and configured to store various information used for the operations for the processor 101. The RF unit 103 is connected to the processor 101 and configured to send and/or receive a radio signal. The processor 101 implements the proposed functions, processed, and/or methods. In the described embodiments, the operation of the UE may be implemented by the processor 101.

The eNodeB (including CeNodeB and UeNodeB) 200/300 includes a processor 201/301, memory 202/302, and an RF unit 203/303. The memory 202/302 is connected to the processor 201/301 and configured to store various information used for the operations for the processor 201/301. The RF unit 203/303 is connected to the processor 201/301 and configured to send and/or receive a radio signal. The processor 201/301 implements the proposed functions, processed, and/or methods. In the described embodiments, the operation of the eNodeB may be implemented by the processor 201.

The processor may include Application-Specific Integrated Circuits (ASICs), other chipsets, logic circuits, and/or data processors. The memory may include Read-Only Memory (ROM), Random Access Memory (RAM), flash memory, memory cards, storage media and/or other storage devices. The RF unit may include a baseband circuit for processing a radio signal. When the above-described embodiment is implemented in software, the above-described scheme may be implemented using a module (process or function) which performs the above function. The module may be stored in the memory and executed by the processor. The memory may be disposed to the processor internally or externally and connected to the processor using a variety of well-known means.

In the above exemplary systems, although the methods have been described on the basis of the flowcharts using a series of the steps or blocks, the present invention is not limited to the sequence of the steps, and some of the steps may be performed at different sequences from the remaining steps or may be performed simultaneously with the remaining steps. Furthermore, those skilled in the art will understand that the steps shown in the flowcharts are not exclusive and may include other steps or one or more steps of the flowcharts may be deleted without affecting the scope of the present invention.

What is claimed is:

1. A method for adjusting a transmission power, the method comprising:
classifying, by a user equipment (UE), a plurality of cells into groups, each of which includes one or more cells belonging to the same base station;
determining, by the UE, a transmission power for each group; and
adjusting, by the UE, the determined transmission power for each group such that a summation of transmission powers for cells included in each group is less than or equal to a maximum transmission power configured for each group.

2. The method of claim 1, further comprising:
determining, by the UE, a transmission power for each cell; and
adjusting, by the UE, the determined transmission power for each cell to be less than or equal to a maximum transmission power configured for each cell.

3. The method of claim 2, further comprising:
adjusting, by the UE, the determined transmission power for each cell such that a summation of transmission powers for the plurality of cells is less than or equal to a maximum transmission power configured for the UE.

4. The method of claim 1, wherein the UE has more than one connectivity to the plurality of cells

5. The method of claim 1, wherein the group is defined per a physical layer entity.

6. The method of claim 1, wherein the maximum transmission power configured for each group is expressed as P_{CMAX,e}.

7. The method of claim 1, the maximum transmission power configured for each group is calculated by amount of uplink (UL) grants.

8. The method of claim 1, the maximum transmission power configured for each group is calculated by amount of UL transmission power.

9. The method of claim 1, the maximum transmission power configured for each group is calculated by channel quality.

10. A user equipment (UE) for controlling a transmission power, the UE comprising:
a transceiver;
a processor connected with the transceiver and configured to
classify a plurality of cells into groups, each of which includes one or more cells belonging to the same base station,
determine a transmission power for each group; and
adjust the determined transmission power for each group such that a summation of transmission powers for cells included in each group is less than or equal to a maximum transmission power configured for each group.

11. The UE of claim 10, wherein the processor is further configured to:
determine a transmission power for each cell; and
adjust the determined transmission power for each cell to be less than or equal to a maximum transmission power configured for each cell.

12. The UE of claim 11, wherein the processor is further configured to:
adjust the determined transmission power for each cell such that a summation of transmission powers for the plurality of cells is less than or equal to a maximum transmission power configured for the UE.
